(19) United States
(12) Patent Application Publication
(10) Pub. No.: US 2017/0005428 A1
(43) Pub. Date: Jan. 5, 2017

(54) CONNECTOR FOR WELLHEAD

(71) Applicant: Amphenol Corporation

(72) Inventor: Robert R. ARCYIEWICZ, Conroe, TX (US)

(21) Appl. No.: 15/194,834

(22) Filed: Jun. 28, 2016

Related U.S. Application Data
(60) Provisional application No. 62/187,560, filed on Jul. 1, 2015.

(51) Int. Cl. H01R 13/40; H01R 43/20; H01R 13/58

(52) U.S. Cl. CPC H01R 13/40; H01R 13/5833; H01R 43/20

(57) ABSTRACT

A connector for a wellhead that includes at least one contact that has a conductor receiving end and an opposite mating end. The conductor receiving end includes a termination passageway. An insert supports the at least one contact. The insert includes an installation end for receiving at least one conductor of a cable and an opposite interface end configured to mate with a mating connector. The insert has at least one inner chamber for retaining the at least one contact.

### RELATED APPLICATION

This application claims priority to and the benefit of U.S. Provisional Application Ser. No. 62/187,560 entitled Connector for Wellhead, filed on Jul. 1, 2015.

### FIELD OF THE INVENTION

The present invention relates to a connector configured to be incorporated into a wellhead of an oil well. More specifically, the connector of the present invention for the wellhead can be terminated directly to a mineral insulated cable of the wellhead, is field installable, and reduces the introduction of hazardous risk involved with soldering near the wellhead. Once installed onto the wellhead, the connector of the present invention is ready to receive its for mating connector, which is terminated to a flexible cable whose opposite end may lead to equipment, such as to temperature monitoring electronic equipment.

### BACKGROUND OF THE INVENTION

Established, producing, oil wells are temperature monitored via access through the wellhead. The wellhead of the oil wells has a fitting that allows a stainless steel tube assembly to be introduced into the well pipe. This tube assembly travels down to the bottom of the well. The assembly is made up of a protective stainless tube (which is typically 3/8″ in diameter) that shrouds a thermocouple cable in a configuration that appears as another stainless steel tube (which is typically 1/8″ in diameter), which runs through the center of the protective 3/8″ tube. The thermocouple cable configuration is referred to as a mineral insulated cable. Mineral insulated (MI) cables are constructed in the following fashion: two or more conductors are positioned within a stainless steel tube; and the conductors are positioned within, and insulated from each other and the outer stainless steel tube, using compressed magnesium oxide as the insulator. This construction permits the MI cable to operate in very high temperatures.

Currently, the industry has no means of terminating a harsh environment connector directly to an MI cable. Instead, the MI cable terminations are usually soldered to a flexible extension cable near the wellhead, which poses safety risks.

Therefore, a need exists for a connector that can be terminated directly to an MI cable, that is field installable, and that reduces the hazardous risk involved when soldering near a wellhead.

### SUMMARY OF THE INVENTION

Accordingly, the present invention may provide a connector for a wellhead that includes at least one contact that has a conductor receiving end and an opposite mating end. The conductor receiving end includes a termination passageway. An insert supports the at least one contact. The insert includes an installation end for receiving at least one conductor of a cable and an opposite interface end configured to mate with a mating connector. The insert has at least one inner chamber for retaining the at least one contact.

The present invention may also provide a connector for a wellhead that includes a plurality of contacts each having a conductor receiving end and an opposite mating end, each of the conductor receiving ends including a termination passageway; an insert for supporting the plurality of contacts, the insert including an installation end for receiving a conductors of a cable and an opposite interface end configured to mate with a mating connector, the insert having a plurality of inner chambers each for retaining one of the plurality of contacts; and a conductor alignment component received in the insert at the installation end thereof, the conductor having a plurality of substantially enclosed passageways, each of the passageways aligns with one of the inner chambers of the insert, the alignment component being stepped such that the plurality of passageways have different longitudinal lengths.

The present invention may further provide a method of terminating a cable to a connector for a wellhead, comprising the steps of installing conductors of the cable in an insert of the connector by aligning the conductors with openings at an installation end of the insert; guiding the conductors into individual chambers of the insert; inserting each conductor into a termination passageway of a conductor receiving end of respective contacts retained in the chambers; inserting each conductor through a slot in a sidewall of each contact, respectively, and through an outer slot opening in the insert corresponding to and in communication with each slot; and pulling and terminating each conductor in each respective slot of the contacts to electrically and mechanically engage each conductor with each contact.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawing figures:

FIG. 1 is a perspective view of an electrical connector according to an exemplary embodiment of the present invention;

FIG. 2 is an exploded view of the connector illustrated in FIG. 1;

FIGS. 3A-D are perspective, end, and cross-sectional views of an insert sub-assembly of the connector illustrated in FIG. 1;

FIGS. 4A-G illustrate the steps of terminating a cable to the connector via the insert sub-assembly illustrated in FIGS. 3A-D;

FIG. 5 is a cross-sectional view of the insert sub-assembly after installation and termination of the conductors to the insert sub-assembly;

FIG. 6 is an enlarged partial perspective view of the contacts of the connector of the present invention, showing the conductors mated with the contacts;

FIG. 7 is an enlarged partial perspective view similar to FIG. 6, showing an insert of the insert subassembly supporting the contacts;

FIG. 8 is an enlarged partial perspective view similar to FIG. 7, showing an insulator disposed on the insert;

FIG. 9 is perspective view of the connector as illustrated in FIG. 8;

FIG. 10 is a perspective view of the connector similar to FIG. 9 with the addition of a threaded connector shell;

FIG. 11 is a perspective view of the connector similar to FIG. 10 with the addition of an assembly sleeve;

FIG. 12 is a perspective view of an insert of a connector in accordance with another exemplary embodiment of the present invention;

FIG. 13 is an exploded perspective of the insert illustrated in FIG. 12;

FIG. 14 is a cross-sectional view of the insert illustrated in FIG. 12; and

FIG. 15 is a perspective view of an alignment component of the insert illustrated in FIG. 12.

### DETAILED DESCRIPTION OF THE INVENTION

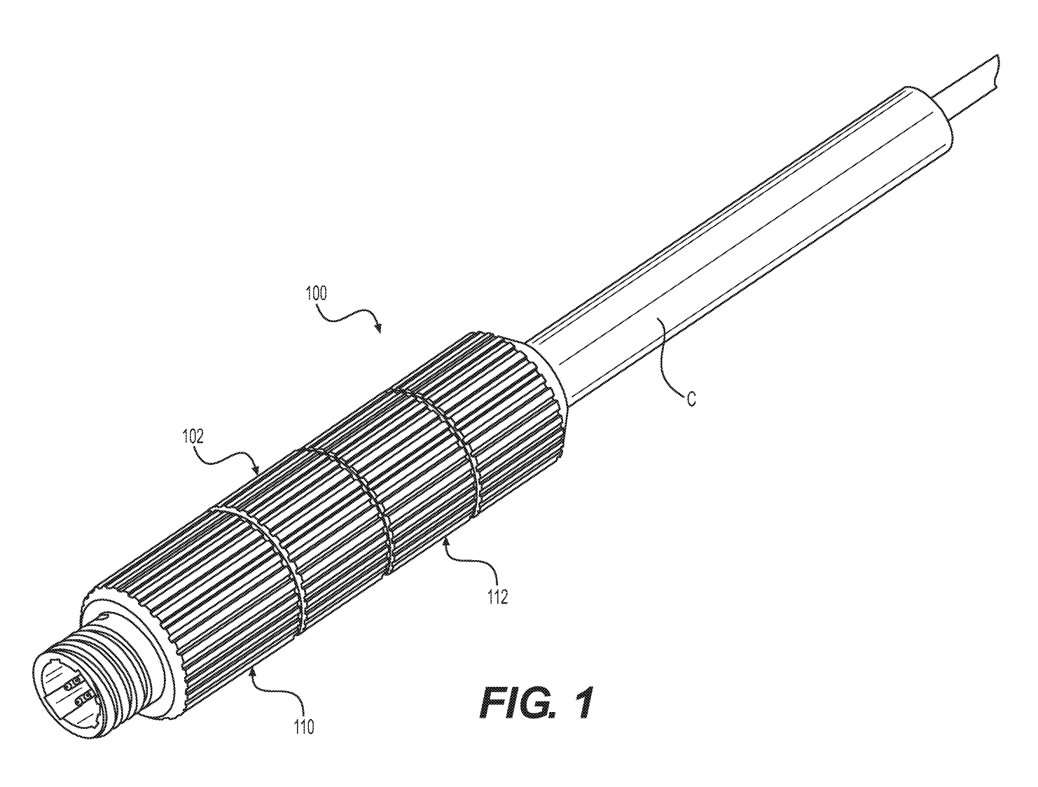

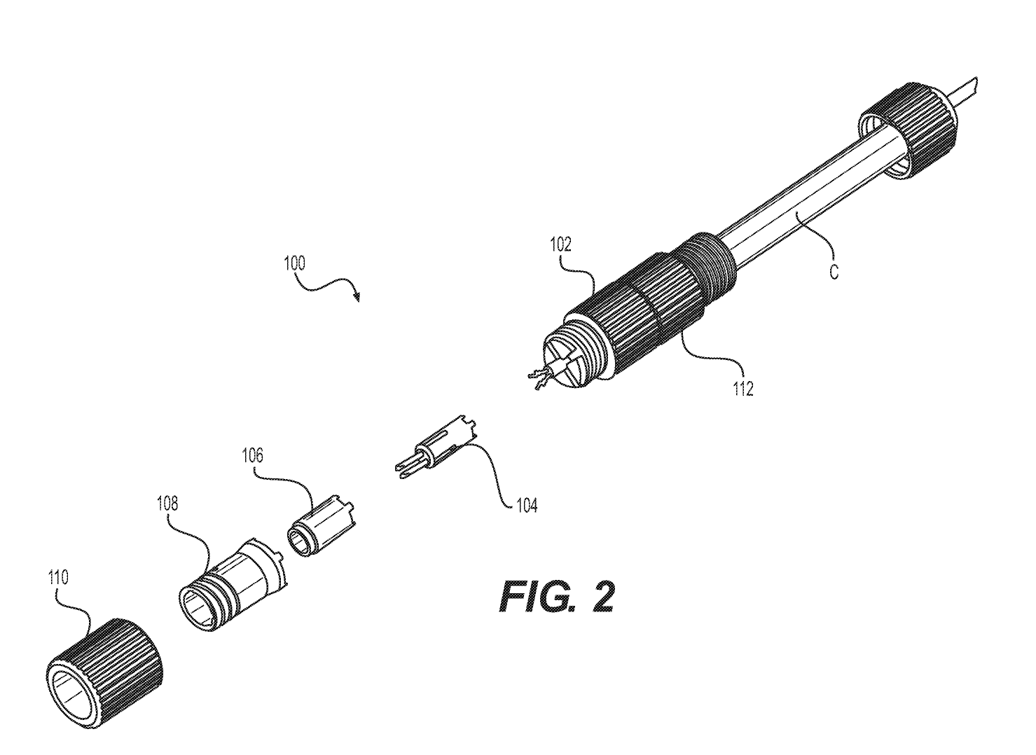

Referring to FIGS. 1, 2, 3A-D, 4A-G, and 5-11, the present invention is an electrical connector 100 configured to be in connection with a wellhead of an oil well, particularly with the MI cable fitting. The connector of the present invention preferably attaches and seals to a MI cable C, which may include a nested tubing set, whose outer layers are protective, and inner layers function to carry electrical signals the length of the cable. The present invention solves the issue of terminating the MI cable of a wellhead by configuring the connector to be terminated directly to the MI cable. The connector of the present invention is also designed to be field installable. The connector reduces the introduction of hazardous risk involved with soldering near the wellhead as soldering the MI cable to the wellhead is no longer necessary. Once installed onto the wellhead, the connector of the present invention is ready for mating with its mating connector (such as a plug), where such mating connector may be terminated to a flexible cable whose opposite end leads to equipment, such as temperature monitoring electronic equipment.

In general, the connector 100 of the present invention includes a connector base 102 supporting the tubing of the MI cable C, an insert sub-assembly 104, an insulator 106, and a connector shell 108, as seen in FIG. 1. An assembly sleeve 110 may also be provided that captures the base 102, the insert sub-assembly 104, the insulator 106, and the shell 108. The assembly of the connector may also sealing components, which are fitted to the outer 3/8″ protective tubing of the MI cable C, a transition body 112 that transitions from the 3/8″ tubing to the 1/8″ tubing of the MI cable, and sealing components that are fitted to the 1/8″ tubing of the MI cable.

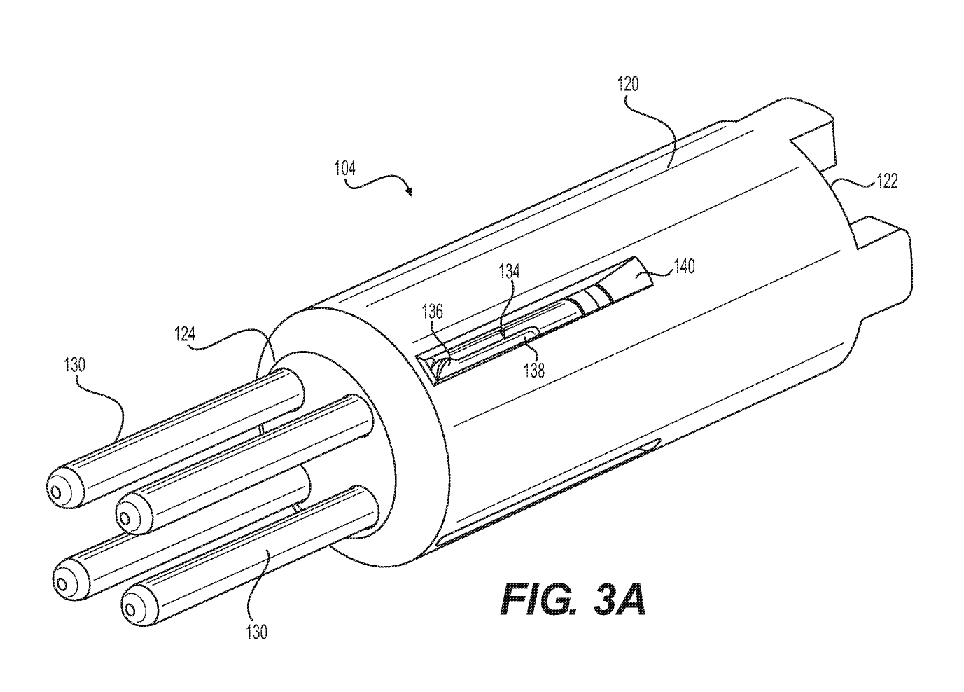

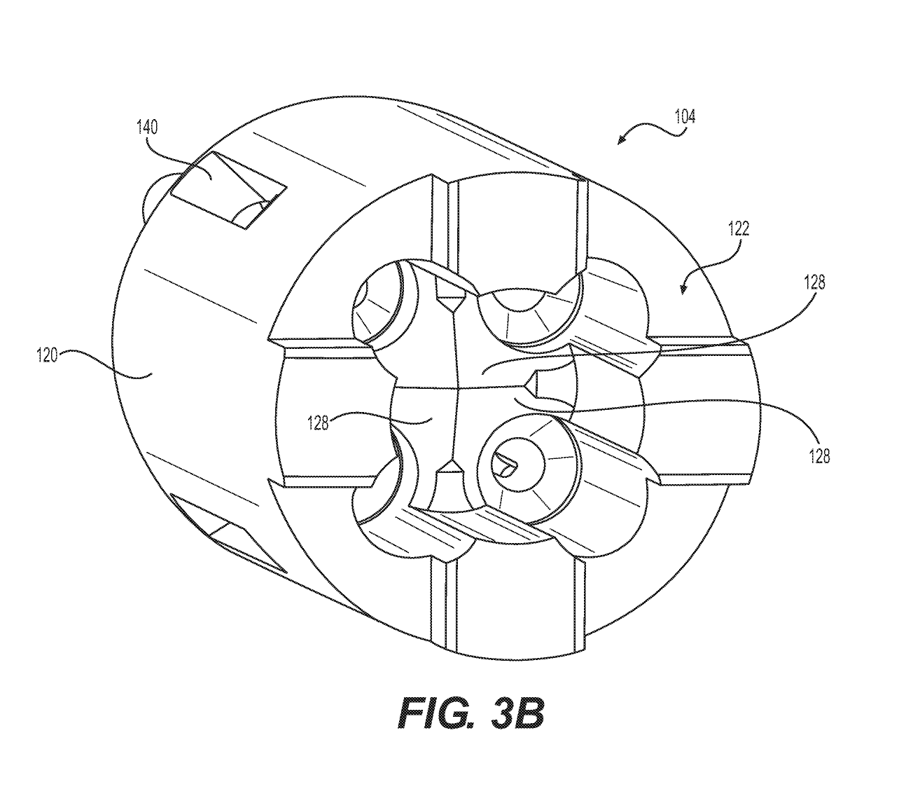

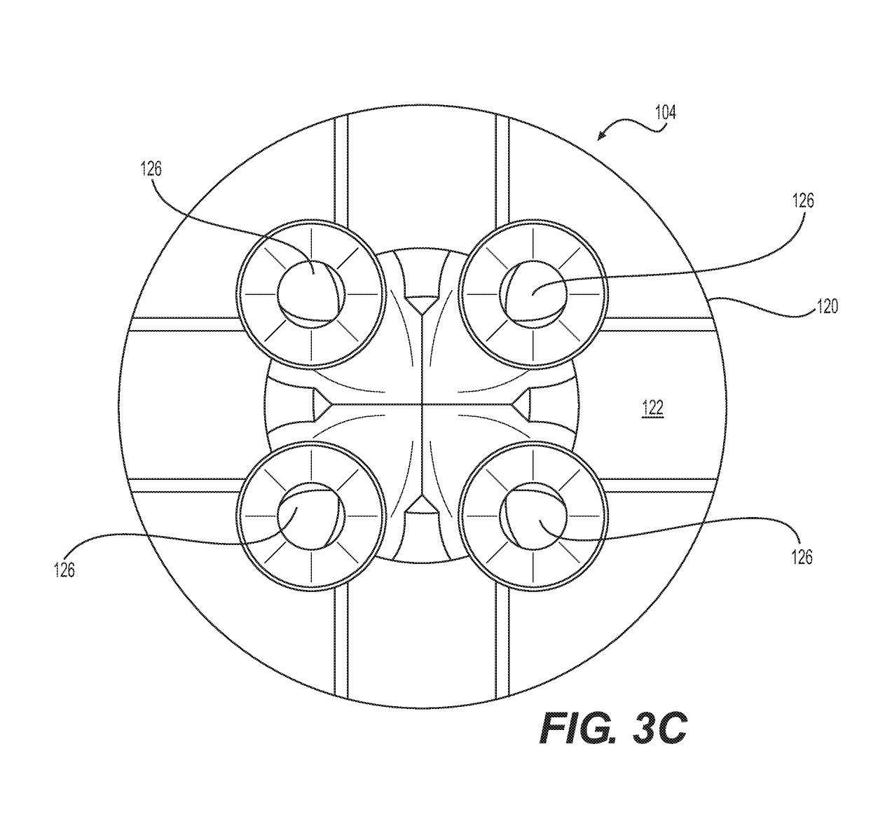

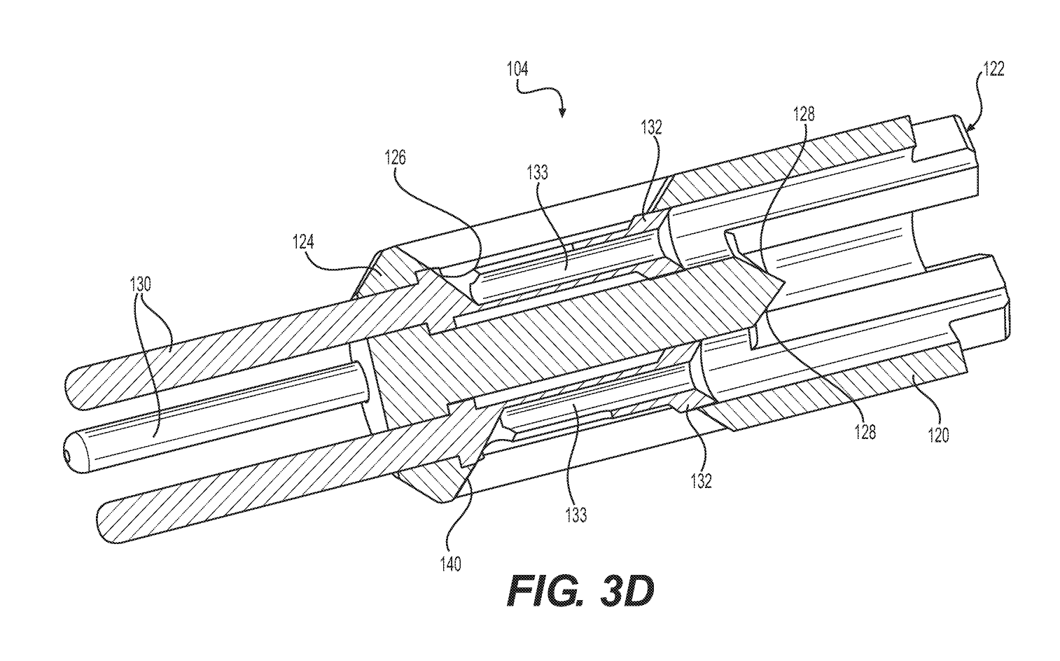

As seen in FIGS. 3A-3D, the insert sub-assembly 104 includes an insert 120 that supports a plurality of contacts 130. The insert 120 includes an installation end 122 for receiving the conductors of the MI cable and an opposite interface end 124 configured to mate with a mating connector. The insert 120 provides alignment and guidance of the conductors within the insert and holds the contacts 130 in place to maintain electrical isolation from themselves and adjacent metal. The insert 120 has a number of inner chambers 126 for retaining the individual contacts 130. Angled faces 128 are provided at the entrance of each chamber 126 to guide the conductors in the chambers 126.

The contacts 130 may be of a solid machined, stamped and formed construction, or a combination of both. The contacts 130 may be either male or female. The contacts 130 preferably incorporate a bifurcated or forked conductor receiving end 132, located anywhere on the shank, aft of the mating end.

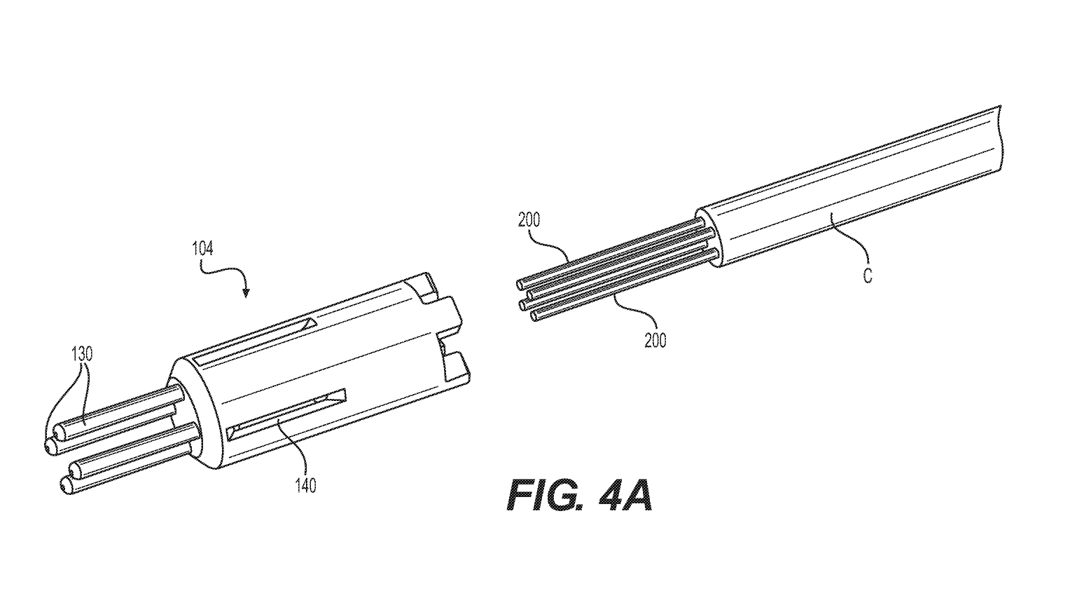

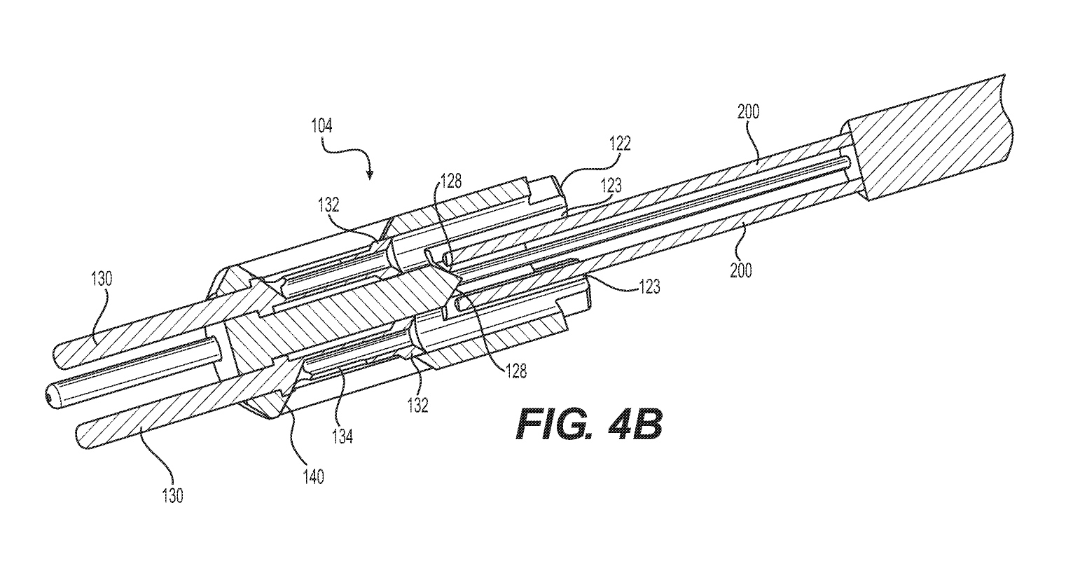

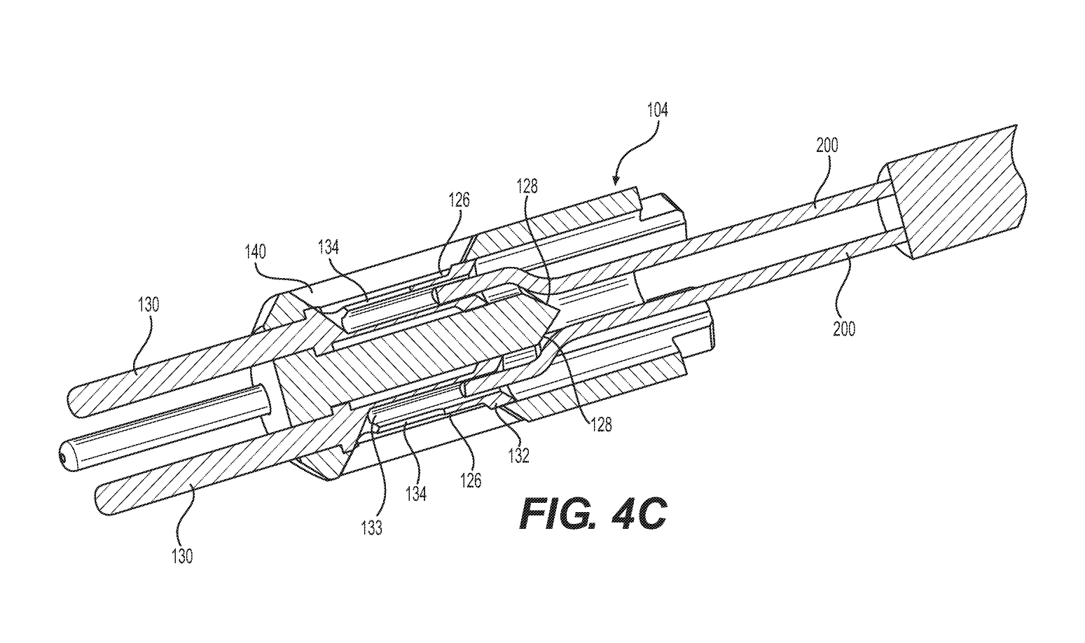

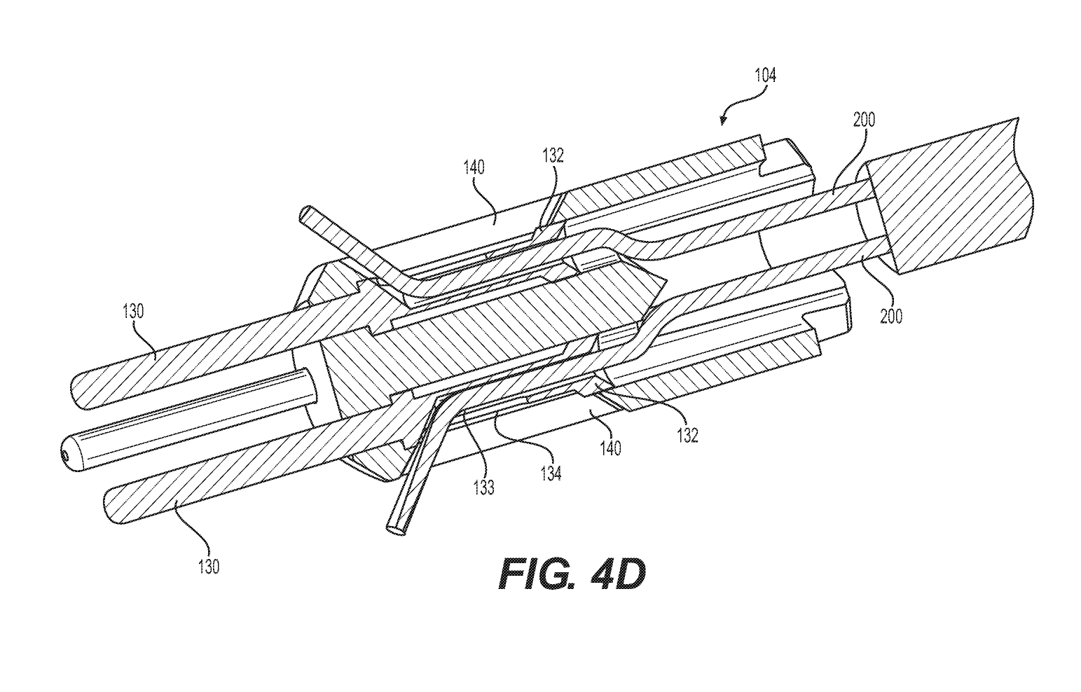

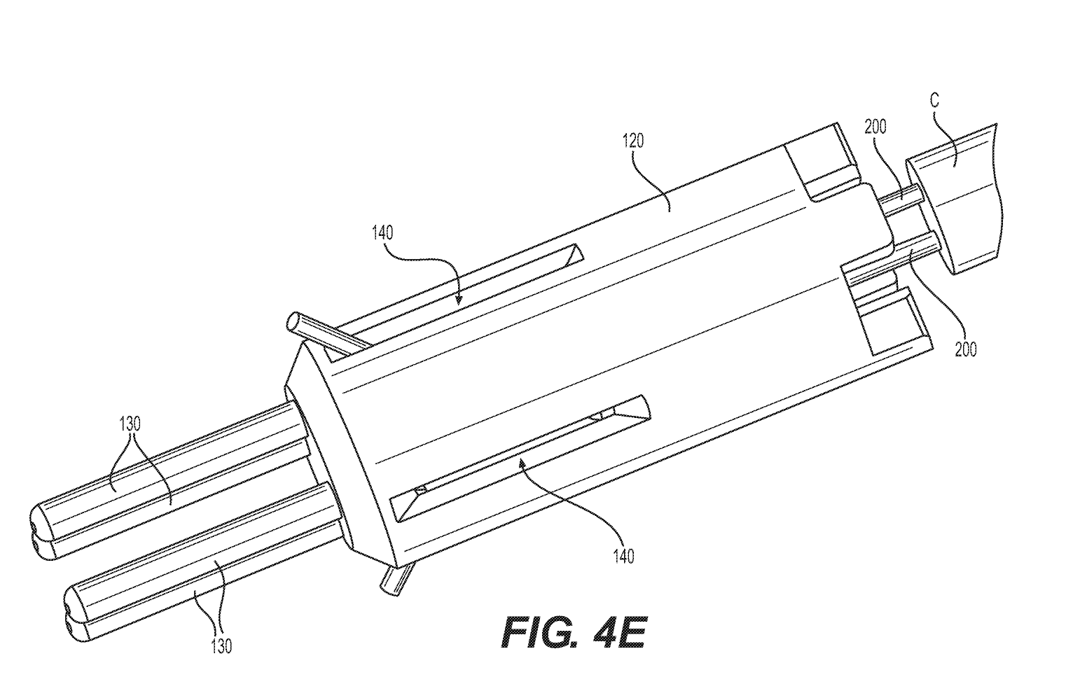

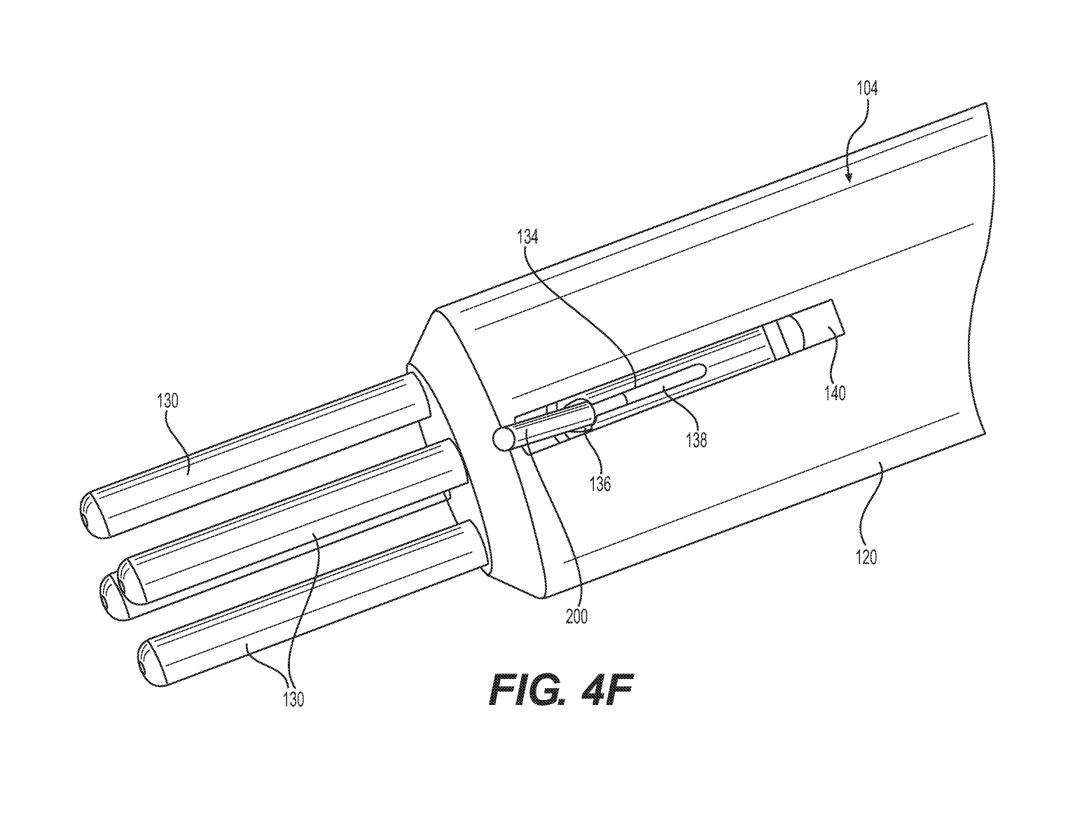

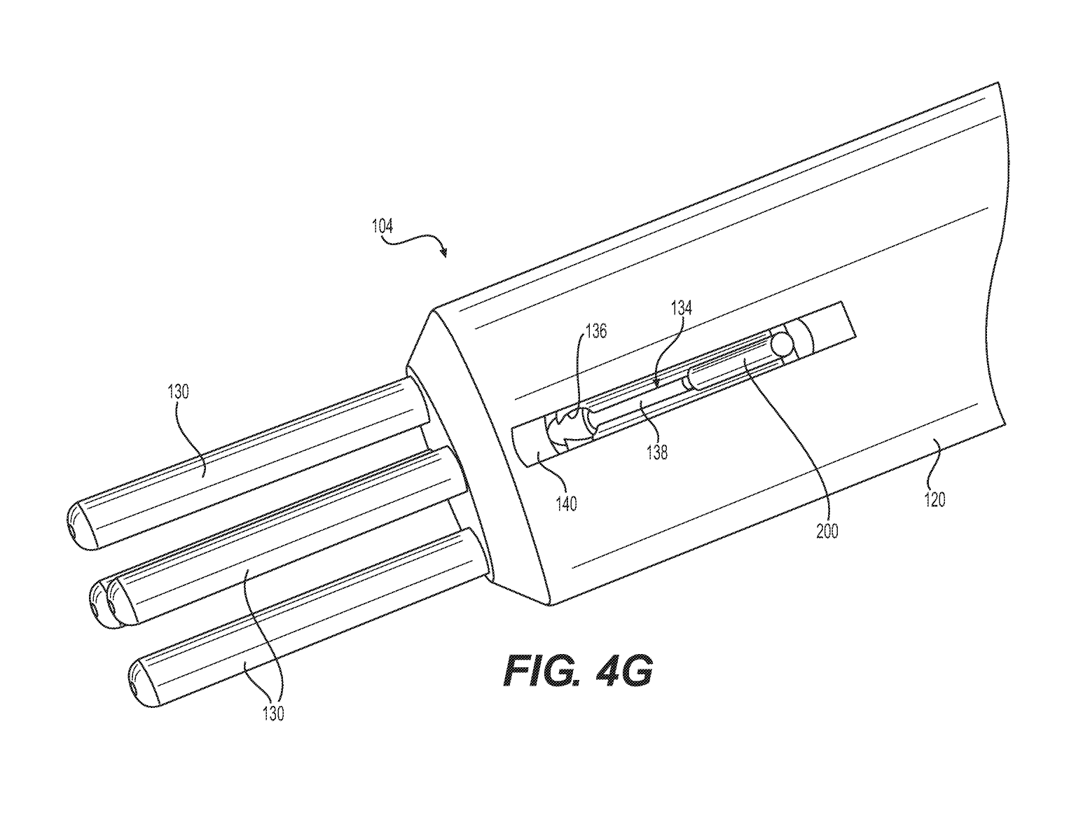

FIGS. 4A-4G illustrate that steps of installing the conductors 200 of the MI cable C in the insert sub-assembly 104, thereby directly terminating the connector 100 to the MI cable C. The conductors 200 of the MI cable C are aligned with and guided through openings 123 in the installation end 122 of the insert 120 of the inner insulator, as seen in FIGS. 4A and 4B. As the conductors 200 enter, the angled faces 128 separate and guide each conductor 200 into a respective chamber 126, as seen in FIG. 4C. The ends of the conductors 200 enter termination passageways 133 of the conductor receiving end 132 of each respective contact 130 which guide the conductor ends up an through and exit a slot 134 in the sidewall of each contact 130, and through a corresponding outer slot opening 140 in the insert 120 that is in communication with the exit slot 134 and the chamber 126, as seen in FIGS. 4D and 4E. The exit slot 134 is preferably in the form of a keyway, as best seen in FIG. 3A. The outer slot opening 140 is preferably aligned with the keyway slot 134, thereby exposing the keyway slot 134 to the outside of the insert 120, as seen in FIG. 3A. Keyway slot 134 may include an entrance end 136 that is substantially circular in shape and sized to receive the end of the conductor 200. An elongated termination section 138 of the keyway slot 134 extends from the entrance end 136 that is sized to pinch the end of the conductor 200.

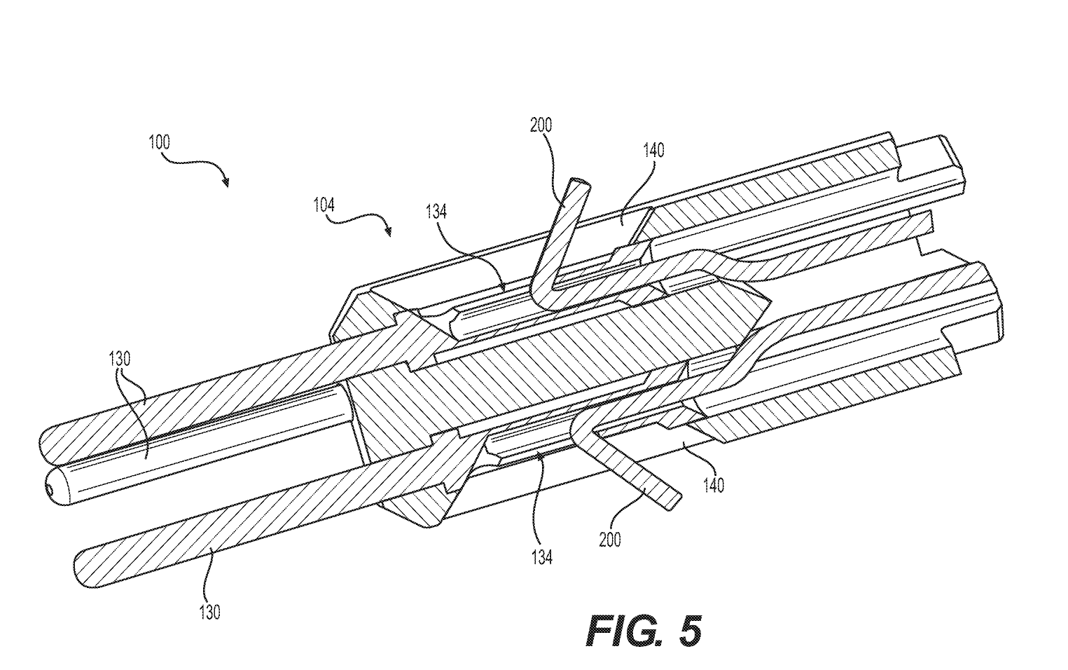

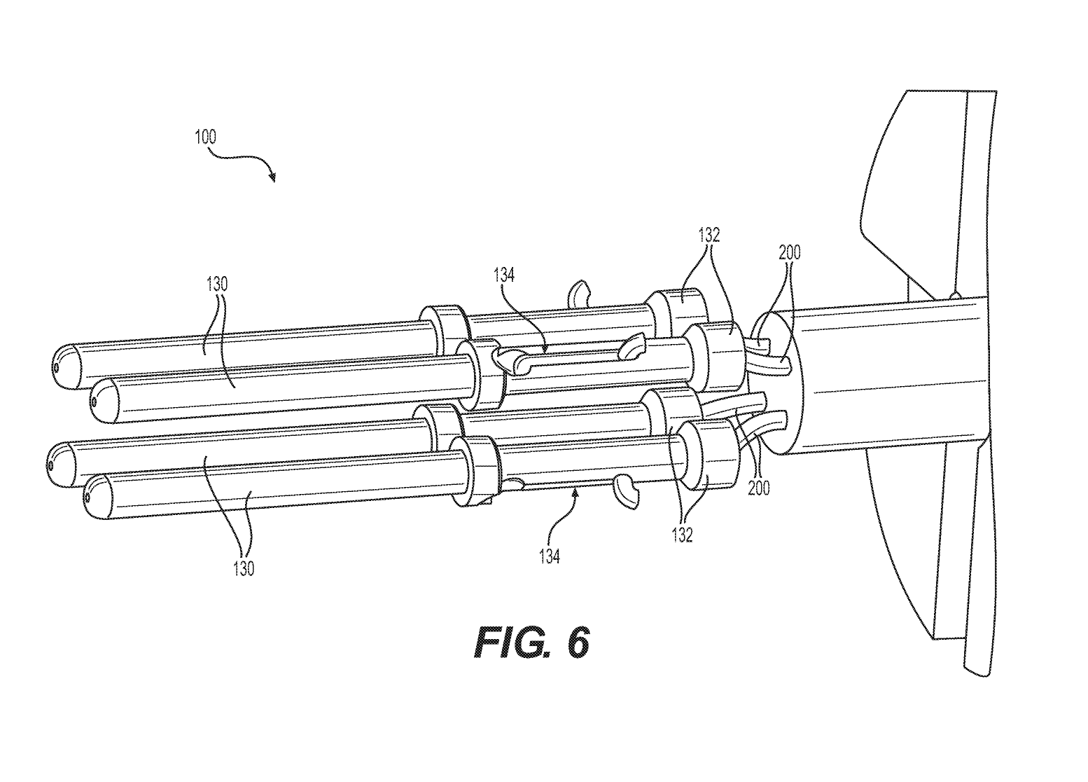

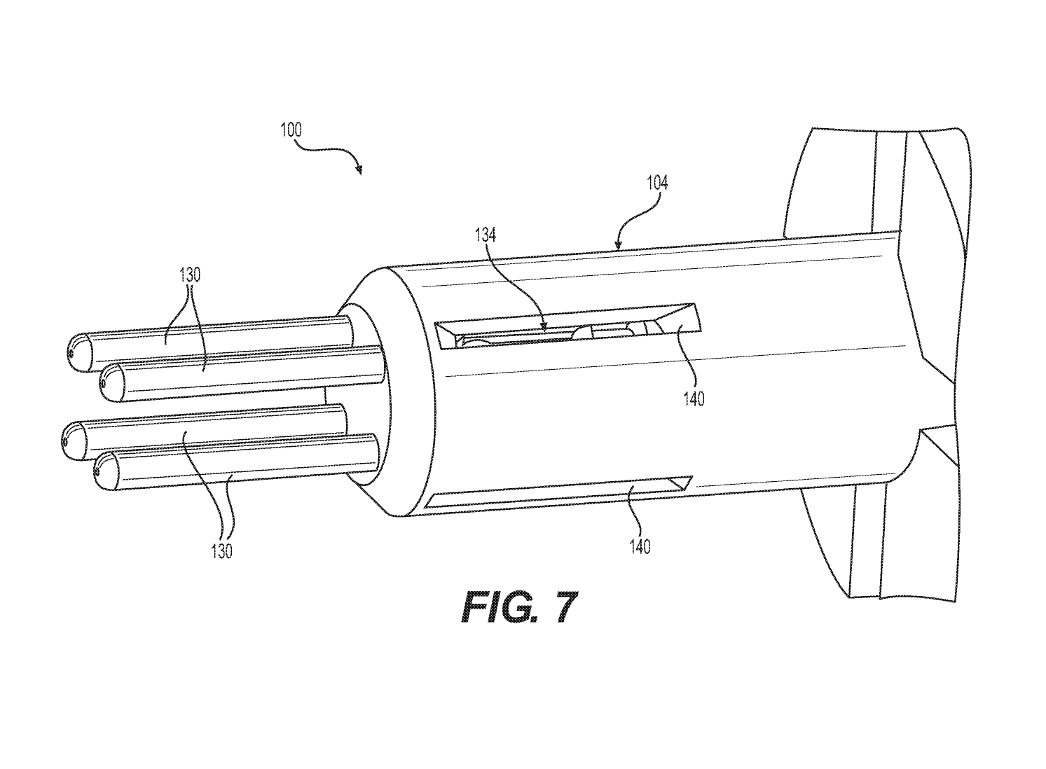

As seen in FIG. 4F, the ends of each conductor 200 extend through each entrance end 136 of the slots 134, respectively, and through the corresponding outer slot opening 140, such that the ends of the conductors 200 extend outside of the insert 120. The ends of each conductor 200 may then be grabbed and pulled into each termination section 138 of their respective contact slots 134 to pinch the conductor ends, as seen in FIGS. 4G, 5, and 6, thereby capturing the conductors and providing the electrical contact force required to transfer an electrical signal, from the conductors 200 to the contacts 130.

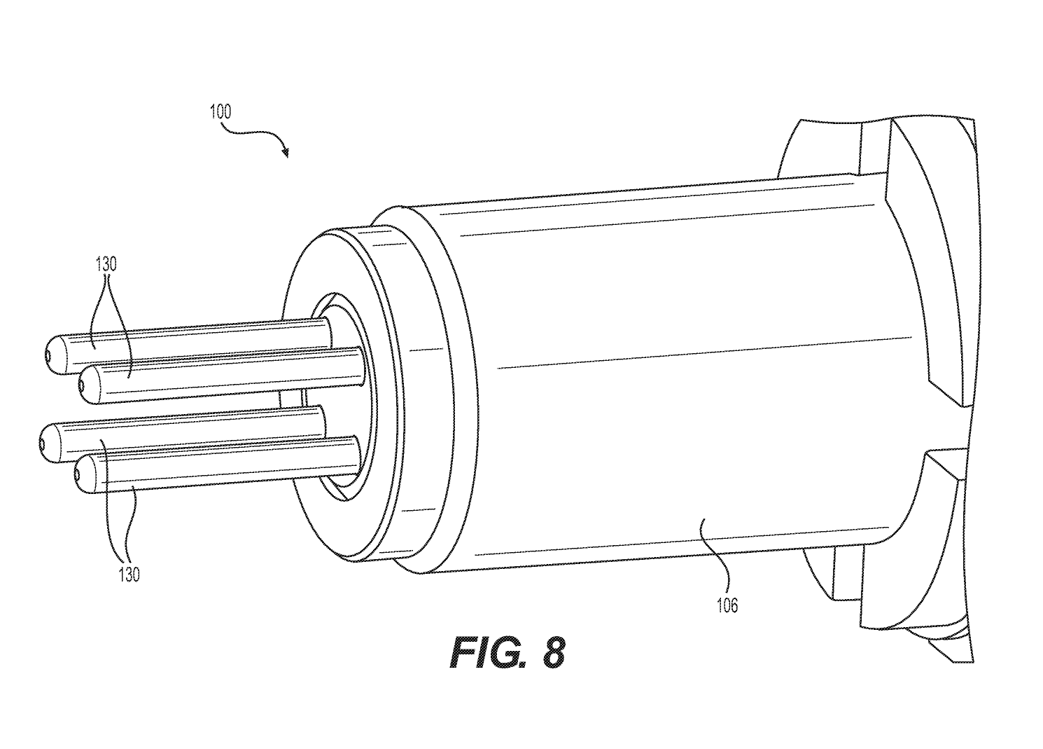

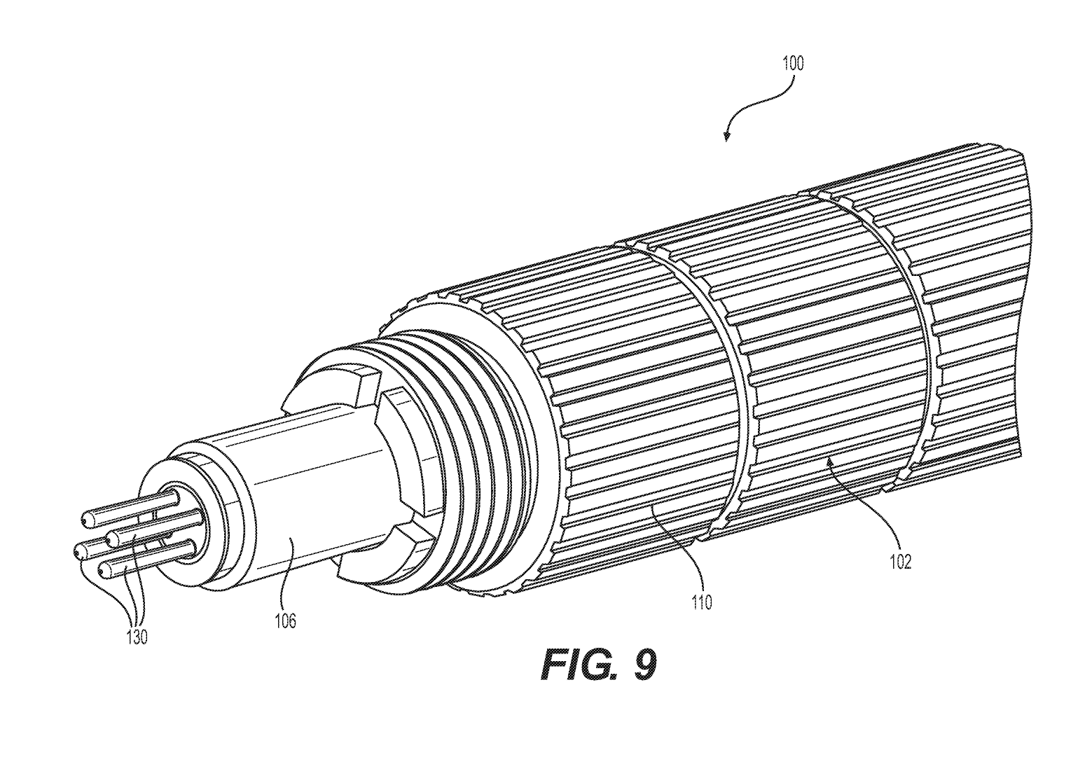

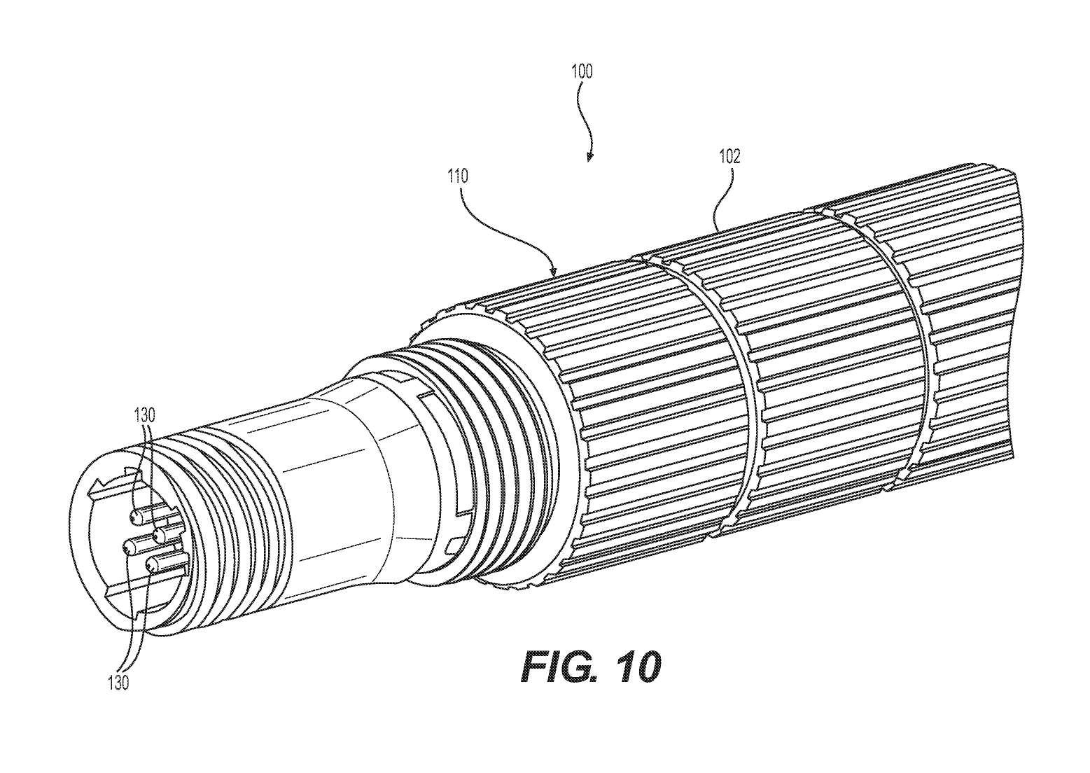

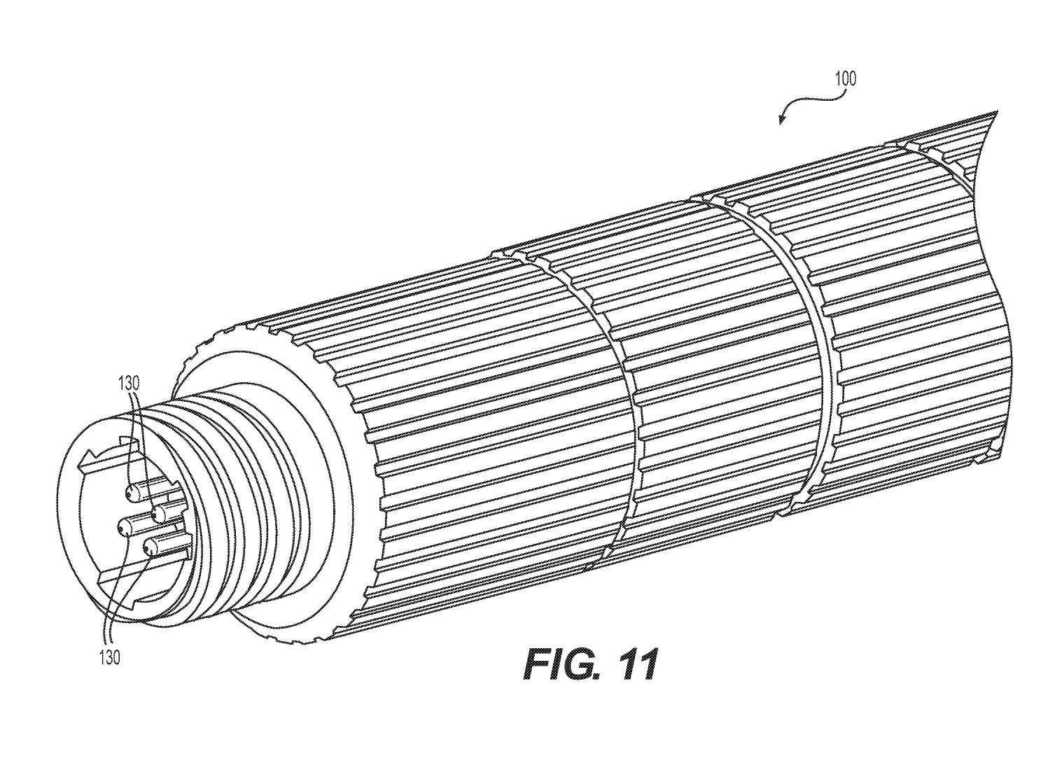

The insulator 106 (FIG. 8) fits over the insert sub-assembly 104 and captures the conductor ends and preferably traps them between the insert 120 and itself, thereby avoiding the chance that they come in contact with the metal outer shell hardware. The connector shell 108 is a separate component and may be held on by a retaining collar. The shell 108 preferably has mating threads which allow the mechanical attachment of a compatible cable mounted component, such as a plug.

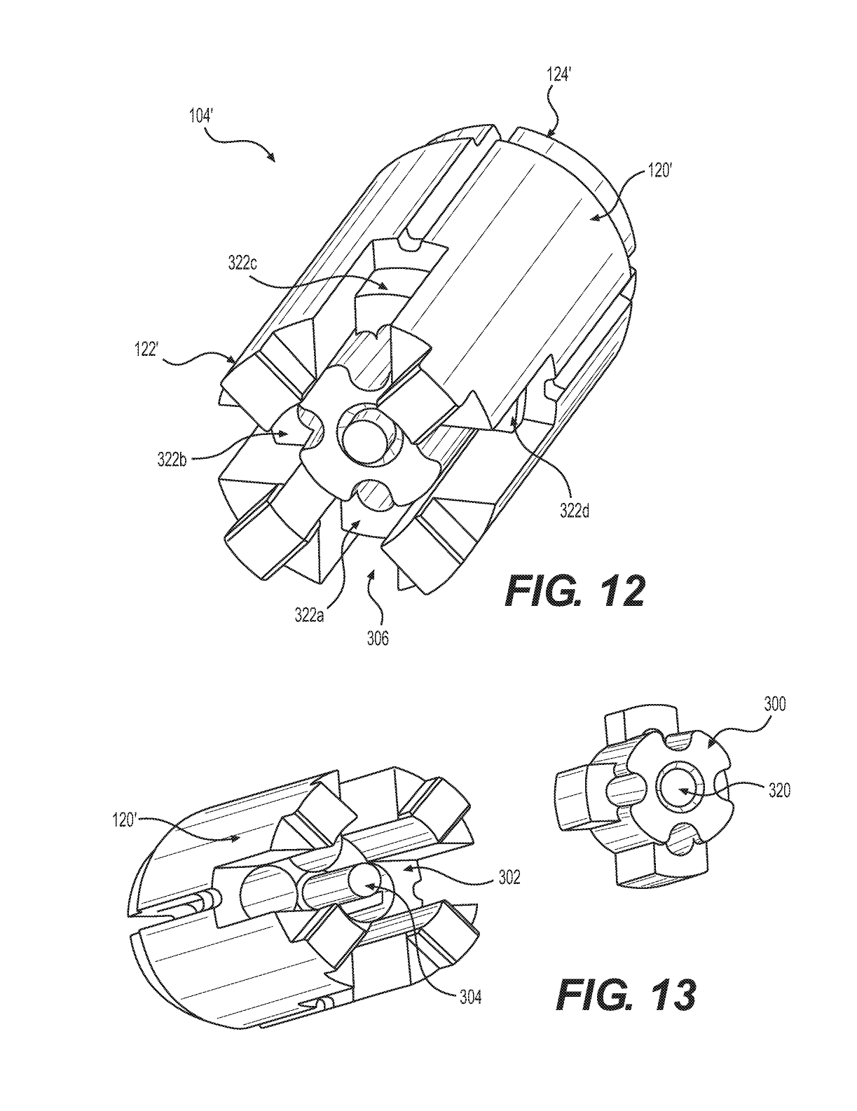

FIGS. 12-15 illustrate a second exemplary embodiment of the present invention which provides an alternative design for the insert sub-assembly. The insert sub-assembly 104′ of the second embodiment includes an insert 120′ with an installation end 122′ for receiving the conductors 200 and an opposite interface end 124′ configured to mate with a mating connector. In the second embodiment, the conductors 200 are electrically and mechanically connected to the contacts 130 in the same manner as discussed above in the first embodiment.

Unlike the insert 120 of the first embodiment, insert 120′ of the second embodiment includes a conductor alignment component 300 (instead of angled surfaces 128) that facilitates alignment and guidance of the conductors into the insert sub-assembly 104′ through the inner chambers 126′ thereof which retain the individual contacts 130. Insert 120′ includes a cavity 302 at its installation end 122′ for receiving the alignment component 300. A stake 304 may be provided in cavity 302 for keying with alignment component 300. Spaced cut-outs 306 may be provided in the body of insert 120′ at installation end 122′ that receive corresponding portions of alignment component 300. Cut-outs 306 are arranged to surround the cavity 302.

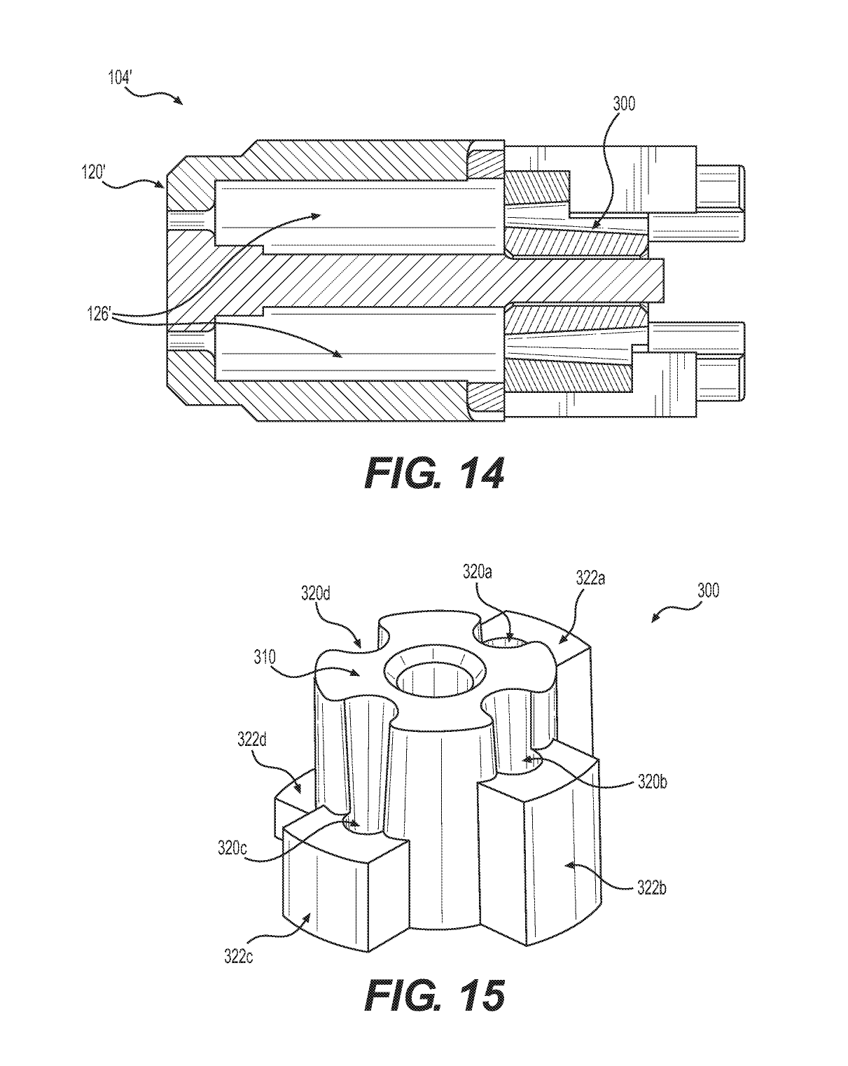

Alignment component 300 includes a stepped main body 310 with a plurality of passageways 320a, 320b, 320c, and 320d each for receiving a conductor 200 and that each align with the individual inner chambers 126′, as best seen in FIG. 14. Each passageway 320a, 320b, 320c, and 320d is defined by an outer step 322a, 322b, 322c, and 322d, respectively, on main body 310. As best seen in FIG. 15, the steps 322a, 322b, 322c, and 322d have different longitudinal lengths such that the substantially enclosed passageways 320a, 320b, 320c, and 320d have different longitudinal lengths to facilitate installation of the conductors 200 Each steps 322a, 322b, 322c, and 322d is received in a respective cut-out 306 of insert 120′, as seen in FIG. 12.

The main body 310 of alignment component 300 may include a hole 330 that is generally central disposed that receives the stake 304 of insert 120′ thereby facilitating insertion and retaining of alignment component 300 in the insert's cavity 302.

In a preferred embodiment, to install the conductors into the insert 120′, the conductors are preferably inserted one at a time, which is facilitated by the design of insert 104′. More specifically, one conductor 200 may be first inserted into the longest passageway 320a which guides that conductor into the inner chamber 126′ that is aligned with the passageway 320a. The insert 120′ can then be rotated so that the next conductor 200 may be inserted into the next longest passageway 320b which guides that conductor into the inner chamber 126′ aligned with passageway 320b. This may be repeated two more times so that conductors are inserted into passageway 320c and then finally into the shortest passageway 320d. The cut-outs 306 allow visualization of the steps 322a, 322b, 322c, and 322d from the outside of the insert 120′. This visualization allows the installer to see the exposed portions of the steps so that the installer can identify the longest to shortest passageways. Thus to begin installation of the conductors, the installer can see that step 322a is the longest and insert the first conductor into the corresponding longest passageway 320a and repeat until the last conductor is inserted into the shortest passageway 320d. Once all of the conductors 200 have been inserted through the inner chambers 126′ with the assistance of alignment component 300, the conductors 300 may be connected to the contacts 130 in the same manner as described above regarding the first embodiment.

The compression sealing components may be of a solid or split type seal, and are removable and replaceable should the connection require service. The configuration is similar to that found in existing sealing glands used on metal tubing.

All components may be keyed to one another to provide positional alignment and securement of the assembly relative to itself, and the mating connector.

While particular embodiments have been chosen to illustrate the invention, it will be understood by those skilled in the art that various changes and modifications can be made therein without departing from the scope of the invention as defined in the appended claims. For example, although four inner chambers 126, 126′ are illustrated, any number of inner chambers may be used including one. Similarly, although four passageways 320a, 320b, 320c, and 320d are illustrated, any number of passageways may be provide along as at some of those passageways have different longitudinal lengths.

What is claimed is:

1. A connector for a wellhead, comprising:
at least one contact, said at least one contact having a conductor receiving end and an opposite mating end, said conductor receiving end including a termination passageway; and
an insert for supporting said at least one contact, said insert including an installation end for receiving at least one conductor of a cable and an opposite interface end configured to mate with a mating connector, said insert having at least one inner chamber for retaining said at least one contact.

2. A connector according to claim 1, wherein
said insert includes at least one outer slot opening that is in communication with said at least one inner chamber and said termination passageway of said at least one contact.

3. A connector according to claim 2, wherein
said termination passageway including a keyway slot for capturing an end of the at least one conductor of the cable.

4. A connector according to claim 3, wherein
said outer slot opening is aligned with said keyway slot, thereby exposing said keyway slot to an outside of said insert.

5. A connector according to claim 3, wherein
said keyway slot includes an entrance end that is substantially circular in shape and sized to receive the at least one conductor of the cable and an elongated termination section that is sized for pinching the at least one conductor.

6. A connector according to claim 2, wherein
said at least one inner chamber includes at least one angled face leading into said at least one chamber to facilitate insertion of the at least one conductor of the cable in said termination passageway.

7. A connector according to claim 1, wherein
said mating end of said at least one contact is configured to engage a mating contact of the mating connector.

8. A connector according to claim 6, wherein
said mating end is one of a pin or socket.

9. A connector according to claim 1, further comprising
an insulator that surrounds and receives said insert, said end of said at least one conductor is sandwiched between said insert and said insulator.

10. A connector according to claim 9, further comprising
a connector shell that surrounds and receives said insulator and said insert.

11. A connector according to claim 1, further comprising
a conductor alignment component received in a cavity of said insert at said installation end, said conductor alignment component having at least one passageway aligned with said at least one inner chamber.

12. A connector according to claim 11, wherein
said insert includes at least one cut-out that receives a step of said at least one passageway such that said may be visualized outside of said insert.

13. A connector for a wellhead, comprising:
a plurality of contacts each having a conductor receiving end and an opposite mating end, each of said conductor receiving ends including a termination passageway;
an insert for supporting said plurality of contacts, said insert including an installation end for receiving a conductors of a cable and an opposite interface end configured to mate with a mating connector, said insert having a plurality of inner chambers each for retaining one of said plurality of contacts; and
a conductor alignment component received in said insert at said installation end thereof, said conductor having a plurality of substantially enclosed passageways, each of said passageways aligns with one of said inner chambers of said insert, said alignment component being stepped such that said plurality of passageways have different longitudinal lengths.

14. A connector according to claim 13, wherein
said insert includes a cavity that receives said conductor alignment component, said cavity having a stake that is keyed with a hole in said conductor alignment component.

15. A connector according to claim 13, wherein
a body of said insert includes a plurality of spaced cut-outs, each of said cut-outs receiving a step of each of said plurality of passageways of said conductor alignment component.

16. A connector according to claim 15, wherein
said steps of each of said plurality of passageways have different longitudinal lengths.

17. A connector according to claim 13, wherein
each of said termination passageways includes a keyway slot for capturing an end of one of the conductors of the cable.

18. A connector according to claim 17, wherein
each of said outer slot openings is aligned with one of said keyway slots, thereby exposing said keyway slots to an outside of said insert.

19. A connector according to claim 18, wherein
each of said keyway slots includes an entrance end that is substantially circular in shape and sized to receive one of the conductors of the cable and an elongated termination section that is sized for pinching the one of the conductor.

20. A method of terminating a cable to a connector for a wellhead, comprising the steps of:
installing conductors of the cable in an insert of the connector by aligning the conductors with inner chambers at an installation end of the insert;
guiding the conductors into the individual inner chambers of the insert;
inserting each conductor into a termination passageway of a conductor receiving end of respective contacts retained in the chambers;
inserting each conductor through a slot in a sidewall of each contact, respectively, and through an outer slot opening in the insert corresponding to and in communication with each slot; and
pulling and terminating each conductor in each respective slot of the contacts to electrically and mechanically engage each conductor with each contact.

21. The method of claim 20, wherein
the step of terminating each conductor includes pinching each end of the conductors in each of the slots, respectively.

22. The method of claim 21, wherein
each slot is a keyway that includes an entrance end that is substantially circular in shape and sized to receive each conductor, respectively, and an elongated termination section that is sized for pinching each conductor, respectively, further comprising the step of
inserting each conductor through the entrance end of each slot, respectively, and pulling each conductor into the elongated termination section of each slot, respectively, to pinch each end of each conductor.

23. The method of claim 20, wherein
each of the chambers of the insert includes an angled face at the entrance thereof; and
the angled faces guide the conductors into the individual chambers.

24. The method of claim 20, wherein
each outer slot opening of the insert is aligned with each slot, respectively, such that each conductor is inserted through each slot, respectively, and through the corresponding outer slot opening in the insert.

25. The method of claim 20, wherein
the step of guiding the conductors into the individual inner chambers of the insert includes first inserting each conductor into an individual passageway of an alignment component received in the insert, each passageway having a different longitudinal length.

26. The method of claim 25, wherein
prior to the step of first inserting each conductor into an individual passageway of the alignment component, visualizing a step of the individual passageway received in a cutout of the insert.

27. The method of claim 26, further comprising the step of
rotating the insert prior to inserting the next conductor into the alignment component.

28. The method of claim 20, wherein
mating ends of that contacts are configured to engage corresponding mating contacts of a mating connector.

29. The method of claim 20, wherein
each of the contacts has a mating end configured to engage a mating contact of the mating connector.

30. The method of claim 20, further comprising the step of
sandwiching ends of the conductors between the insert and an insulator surrounding the insert.
